(19) United States
(12) Patent Application Publication
(10) Pub. No.: US 2022/0129966 A1
(43) Pub. Date: Apr. 28, 2022

(54) METHOD OF TRANSMITTING MESSAGE, ELECTRONIC DEVICE AND STORAGE MEDIUM

(71) Applicant: Beijing Baidu Netcom Science Technology Co., Ltd., Beijing (CN)

(72) Inventor: Minfan LIN, Beijing (CN)

(21) Appl. No.: 17/568,886

(22) Filed: Jan. 5, 2022

(30) Foreign Application Priority Data
Mar. 25, 2021 (CN) 202110321943.4

(51) Int. Cl. G06Q 30/06

(52) U.S. Cl. CPC G06Q 30/0631

(57) ABSTRACT

A method of transmitting a message, an electronic device, and a storage medium, which relate to a field of artificial intelligence technology, and in particular to an intelligent recommendation technology. The method includes: determining at least one object group corresponding to a target object from a plurality of object groups, based on at least one feature of the target object; acquiring at least one candidate message associated with the at least one object group within a predetermined time period, wherein each of the at least one candidate message indicates at least one candidate service to be recommended to an object in the at least one object group; selecting a target message from the at least one candidate message based on the at least one feature; and transmitting the target message to the target object, wherein the target message indicates at least one target service recommended to the target object.

### CROSS REFERENCE TO RELATED APPLICATION(S)

The application claims priority to Chinese patent Application No. 202110321943.4, filed on Mar. 25, 2021, the contents of which are incorporated herein by reference in their entireties.

### TECHNICAL FIELD

The present disclosure relates to a field of artificial intelligence technology, in particular to a field of an intelligent recommendation technology, and more specifically to a method of transmitting a message, an electronic device, a storage medium.

### BACKGROUND

In an information age, recommending messages have become part of people's daily life. For example, a platform usually recommends a service (e.g., a preferential service) that may be provided to a user of the platform, by transmitting a message indicating an information of an electronic feedback (e.g., coupons, member privileges, check-in benefits, etc.), so as to promote the user of the platform to acquire a desired service. However, existing recommendation systems usually use various recommendation strategies to determine what messages to be transmitted to which users, which results in a low efficiency. Moreover, as various recommendation strategies may be directed to a same user, the user may receive a plurality of recommendation messages in a short time period, which results in poor user experience, and further may cause user complaints.

### SUMMARY

The present disclosure provides a method of transmitting a message, an electronic device, and a storage medium.

According to a first aspect of the present disclosure, a method of transmitting a message is provided, and the method includes: determining at least one object group corresponding to a target object from a plurality of object groups, based on at least one feature of the target object; acquiring at least one candidate message associated with the at least one object group within a predetermined time period, wherein each of the at least one candidate message indicates at least one candidate service to be recommended to an object in the at least one object group; selecting a target message from the at least one candidate message based on the at least one feature; and transmitting the target message to the target object, wherein the target message indicates at least one target service recommended to the target object.

According to a second aspect of the present disclosure, an electronic device is provided, and electronic device includes: at least one processor; and a memory communicatively connected to the at least one processor, wherein the memory stores instructions executable by the at least one processor, and the instructions, when executed by the at least one processor, cause the at least one processor to implement the method described according to the first aspect of the present disclosure.

According to a third aspect of the present disclosure, a non-transitory computer-readable storage medium having computer instructions stored thereon is provided, wherein the computer instructions are configured to cause a computer to implement the method described according to the first aspect of the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The above and other features, advantages and aspects of the embodiments of the present disclosure will become more apparent in combination with the accompanying drawings and with reference to the following detailed description. The accompanying drawings are used to understand the solution better and do not constitute a limitation to the present disclosure. In the accompanying drawings, same or similar reference numerals indicate same or similar elements.

FIG. 1 shows a schematic diagram of an exemplary environment in which various embodiments of the present disclosure may be implemented.

FIG. 2 shows a flowchart of a method of transmitting a message according to some embodiments of the present disclosure.

FIG. 3 shows a schematic diagram of a method of transmitting a message according to some embodiments of the present disclosure.

FIG. 4 shows a schematic block diagram of an apparatus of transmitting a message according to some embodiments of the present disclosure.

FIG. 5 shows a block diagram of an electronic device for implementing various embodiments of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

In the description of the embodiments of the present disclosure, the term “including” and similar terms should be understood as open-ended inclusion, that is, “including but not limited to”. The term “based on” should be understood as “at least partially based on.” The term “an embodiment” or “this embodiment” should be understood as “at least one embodiment.” The terms “first,” “second,” and the like may refer to different objects or a same object. The following may also include other explicit and implicit definitions.

In the description of the embodiments of the present disclosure, the term “service” refers to a service that may be provided by an application or a platform. In some embodiments, in order to promote a user of an application or a platform to use the application or the platform, the service may include various benefits provided by the application or the platform to the user. For example, the service may include at least one of: different levels of member services, feedbacks for users (e.g., coupons, extension of member service term, or discount), various interactive activities for enhancing user stickiness (for example, check-in, game activities for acquiring various benefits, etc.). In some embodiments, the application or the platform may be an application including a message recommendation system, including but not limited to a library application, a shopping application, a short video application, a music application, a dating application, a news application, a post bar application, a cloud disk storage application, a search application, and so on, which is not limited in the present disclosure.

In the description of the embodiments of the present disclosure, the term “object” may refer to a user of an application or a platform, or may refer to various devices through which the user may interact with the application or the platform, such as a computer, a smart phone, a tablet, a smart watch, and so on.

In the description of the embodiments of the present disclosure, the term “feature” may refer to various information of an object or a user that operates an object, such as basic attributes and preferences, the basic attributes include a user profile information used to characterize a user related information, and the preferences include user's content preferences, application or platform preferences, and behavioral preferences. In some embodiments, the feature may be represented by a label or other suitable means. In the technical solution of the present disclosure, acquisition, storage and application of various information of the user involved comply with provisions of relevant laws and regulations, and do not violate public order and good custom.

In the description of the embodiments of the present disclosure, the term “message” refers to a content transmitted (e.g., pushed) to a target object through various manners, which may take forms of text, picture and video. The various manners include, but are not limited to short message, official account message, application pop-up, application notification, and so on. In some embodiments, the message may be used to present various services recommended by the application or the platform to the target object.

As discussed above, there may be a plurality of recommendation strategies that match a specific target object, and a plurality of messages may be transmitted to the target object in a short time period. Such the way may cause a waste of resources and poor user experience, and in turn reduce an effectiveness of a message. In some solutions, a threshold for a number of messages transmitted to a same target object within a predetermined time period may be set, and it is possible to stop transmitting a message to a target object in response to the number of messages transmitted reaching the threshold. However, such a solution cannot ensure a highest matching degree between the message transmitted and the target object.

In order to solve at least partially one or more of the above problems and other potential problems, the embodiments of the present disclosure propose a method of selecting a message to be transmitted to the target object within a predetermined time period. A computing device may firstly determine a number of messages to be transmitted to the target object within a predetermined time period according to one or more recommendation strategies corresponding to one or more object groups including the target object. The messages are used to recommend services to an object. If the number is greater than a predetermined threshold (e.g., 1), the computing device may compare a label set for features of an object group corresponding to each message with a label set for features of the target object. Based on a comparison result, the computing device may select a predetermined threshold number of messages with a high overlapping degree of features as the messages to be transmitted, and present the messages to the target object at an appropriate time through an appropriate manner.

In this way, the number of messages transmitted to the target object within the predetermined time period may be ensured, and the matching degree of the message transmitted and the target object may be ensured, so as to promote the target object to use the recommended service as much as possible.

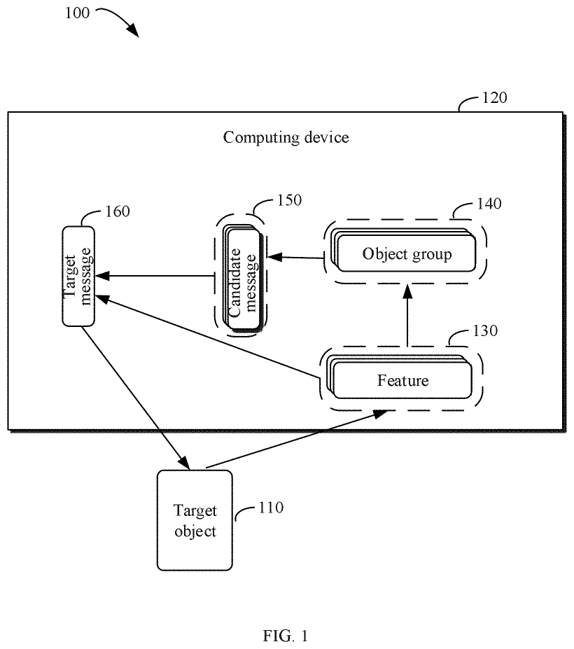

FIG. 1 shows a schematic diagram of an exemplary environment 100 in which various embodiments of the present disclosure may be implemented. As shown in FIG. 1, the exemplary environment 100 may include a computing device 120, a target object 110, a feature 130 of the target object 110, at least one object group 140, at least one candidate message 150, and a target message 160. The computing device 120 may be any device with computational power. As an unrestricted example, the computing device 120 may be any type of fixed computing device, mobile computing device or portable computing device, including but not limited to a desktop computer, a laptop computer, a notebook computer, a netbook computer, a tablet computer, a multimedia computer, a mobile phone, and so on. All or a part of components of the computing device 120 may be distributed in a cloud. The computing device 120 at least includes a processor, a memory, and other components commonly present in a general-purpose computer, so as to implement functions such as computation, storage, communication, control, and so on.

The target object 110 may have one or more features 130, and the one or more features 130 include but are not limited to the various information discussed above. In some embodiments, one or more labels for the target object may be determined based on an analysis of the one or more features 130, and then one or more object groups 140 associated with the target object 110 may be determined. Each object group may include a group of objects, and each object in the group of objects has a same set of features or labels.

The candidate message 150 for each object group may be determined based on a recommendation strategy. Therefore, a content of the candidate message 150 may match a feature of each object in the object group and may therefore be of interest to the target object 110. It may be understood that when the target object 110 corresponds to a plurality of object groups 140, a plurality of candidate messages 150 may be transmitted to the target object 110 belonging to the plurality of object groups 140.

Therefore, the computing device may be used to filter the plurality of candidate messages 150 based on the feature 130 of the target object, so as to determine at least one target message 160 to be transmitted to the target object 110, and the at least one target message 160 may be those of the plurality of candidate messages 150 more matching the feature 130 of the target object. Additionally or alternatively, the computing device may be further used to determine a transmission parameter, such as a transmission time, a transmission manner, etc., for transmitting the target message 160 based on the feature 130.

It should be understood that the architecture and functions in the environment 100 are described for illustrative purposes only, without implying any limitation on the scope of the present disclosure. For example, although only one target object 110 is illustrated in FIG. 1, the number of the target objects is only exemplary. Those skilled in the art may understand that the embodiments of the present disclosure may apply a plurality of target objects.

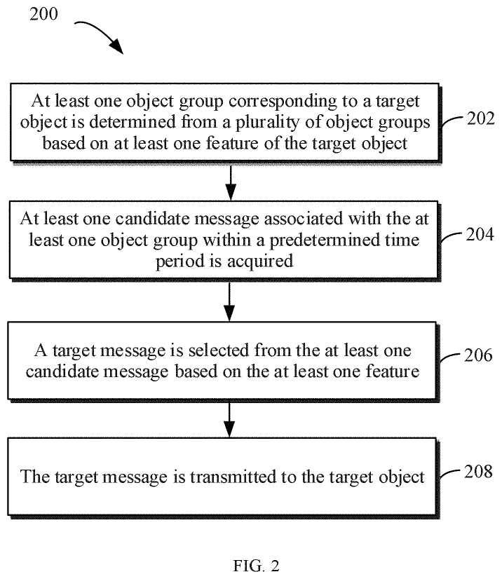

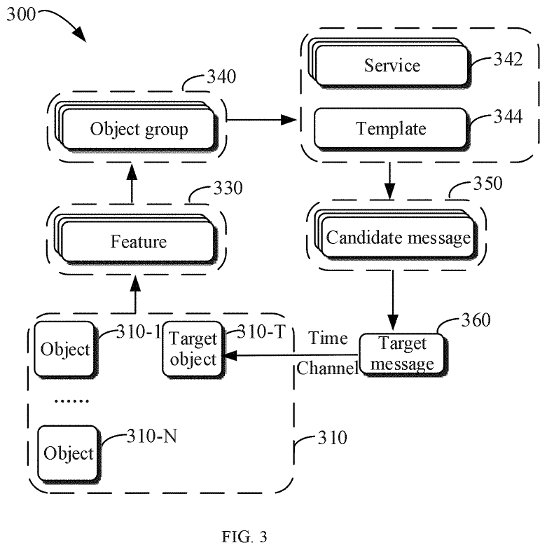

The method according to some embodiments of the present disclosure will be described in detail below with reference to FIG. 2 and FIG. 3. For ease of understanding, specific data mentioned in the following description are all exemplary and are not used to limit the protection scope of the present disclosure. For ease of description, the method according to some embodiments of the present disclosure is described below in connection with the exemplary environment 100 shown in FIG. 1. The method according to some embodiments of the present disclosure may be implemented in the computing device 120 shown in FIG. 1 or other suitable devices. It should be understood that the method according to some embodiments of the present disclosure may further include additional actions not shown and/or the actions shown may be omitted, and the scope of the present disclosure is not limited in this respect.

FIG. 2 shows a flowchart of a method 200 of transmitting a message according to some embodiments of the present disclosure.

In step 202, the computing device 120 may determine at least one object group corresponding to a target object from a plurality of object groups, based on at least one feature of the target object. In some embodiments, the plurality of object groups may be predetermined, and each object group may have a predetermined label set. With reference to FIG. 3 for illustration, FIG. 3 shows a schematic diagram of a method 300 of transmitting a message according to some embodiments of the present disclosure. The computing device may determine the plurality of object groups by the following steps. The computing device may firstly acquire at least one object feature of each of objects 310-1 to 310-T in an object set 310. It may be understood that the object set 310 may include the target object 310-T. In some embodiments, the object set may be a universal set of objects using a specific application or platform. Then, an object feature set 330 may be acquired by combining at least one object feature of each object. In some embodiments, the object feature set may be a universal set of features of objects using a specific application or platform. The computing device may acquire a plurality of object feature subsets based on the object feature set, and determine a plurality of object groups 340 from the object set. Each object group is associated with an object feature subset in the plurality of object feature subsets. In some embodiments, a selection of features in the object feature subset is associated with a recommendation strategy. In other words, the object feature subset may describe a portrait of a specific object group, and the recommendation strategy may target the specific object group. By predetermining a plurality of object groups corresponding to a plurality of recommendation strategies, respectively, it is possible to improve an efficiency of subsequently customizing a generation of message and a transmission of message based on the object groups. Accordingly, resources required for development may be saved.

In some embodiments, the features of the target object may match the features of more than one of the plurality of object groups 340. For example, the target object 310-T may have a first label such as “35 years old”, a second label such as “male”, a third label such as “occupation A”, a fourth label such as “doctor”, a fifth label such as “with children”, a sixth label such as “Beijing”, a seventh label such as “chess”, and an eighth label such as “high income”. Accordingly, the target object 110 may belong to a first object group including a group of objects with labels of “35 years old”, “male”, “programmer”, “with children” and “Beijing”, and also belong to a second object group including another group of objects with labels of “male”, “Beijing”, “chess” and “high income”.

In some embodiments, the computing device may re-determine at least one object group corresponding to the target object in response to a change of at least one feature of the target object 310-T. For example, if the third label for the target object 310-T is changed from “occupation A” to “occupation B”, it may be determined that the target object 310-T does not belong to the first object group and may in turn belong to another object group in the plurality of object groups 340. In this way, an adjustment may be made in real time based on the change of the feature of the object, so that the recommendation strategy may involve new objects meeting predetermined conditions in real time.

With reference to FIG. 2, in step 204, the computing device 120 may acquire at least one candidate message associated with the at least one object group determined within a predetermined time period. Each of the at least one candidate message indicates at least one candidate service to be recommended to an object in the at least one object group. With reference to FIG. 3, the computing device may determine the candidate message 350 in the unit of the object group 340 according to the recommendation strategy. Each object group may correspond to a candidate message associated with the object group. For example, in a case that the target object 310-T belongs to each of a first object group to a sixth object group, the computing device 120 may determine that objects (including the target object) that commonly belong to some object groups (e.g., the first object group to the fourth object group) of the first to sixth object groups may all receive candidate messages (for example, a total of four candidate messages including a first candidate message to a fourth candidate message) corresponding to the some object groups respectively within a predetermined time period. In some embodiments, the predetermined time period may be one day, one week, or other suitable predetermined time period. In some embodiments, the predetermined time period may also be dynamically adjusted based on a total frequency of the recommendation strategy being triggered recently.

In some embodiments, the computing device 120 may automatically generate a candidate message for an object group. The computing device may acquire at least one object feature subset (e.g., an object that commonly belongs to the first object group to the fourth object group has a first label subset to a fourth label subset) associated with the at least one object group determined (e.g., the first object group to the fourth object group). Then, the computing device 120 may determine at least one service 342 based on the at least one object feature subset. The at least one service 342 may be sensitive (in other words, of interest) to the objects in the determined at least one object group and may therefore promote the objects in the object groups to perform at least one behavior such as click, use, purchase and/or payment for the at least one service. Examples of the service include, but are not limited to membership privileges provided by the application or the platform, and feedback provided by the application or the platform (e.g., points, price concessions, vouchers). In some embodiments, the computing device may determine a corresponding service list for each feature in the object feature subset, and then combine and/or filter a plurality of service lists corresponding to a plurality of features, so as to determine at least one service. The at least one service may correspond to various feature dimensions of the object group. In some embodiments, the at least one service ultimately recommended to each object in the object group may be the same. Additionally or alternatively, in addition to the at least one service determined based on the object feature subset, other services of interest to each object may be further determined as at least part of the content recommended in the message.

The computing device 120 may generate at least one candidate message 350 based on the at least one service. The at least one candidate message 350 may contain content for recommending the determined at least one service, such as text, picture, or video. In some embodiments, each candidate message may contain the content for recommending combined plurality of services. Therefore, the candidate message generated in this way may contain a service corresponding to the object group, so as to promote the target object to subsequently perform potential operations for the recommended service.

Additionally or alternatively, the computing device 120 may determine at least one message template 344 for generating the at least one candidate message, based on the at least one object feature subset. Template content in the message template determined based on the feature subset may be of interest to an object in the object group. In some embodiments, when the candidate message takes the form of text, the message template may contain a word that the object is sensitive to, and one or more reserved fields that may be filled with the features of the target object and/or the determined at least one service. For example, for the first object group described above, an example of the message template may be “Dear AAA (name or identifier of the target object), today is Children's Day. BBB (a first service, e.g., member privilege) is being sold at CCC (a second service, e.g., discounts or member term extension) for a limited time with free DDD (a third service, e.g., feedback such as member points, coupons, etc.). Still waiting for what?” It may be understood that, message templates corresponding to different object groups will not necessarily be the same. In other embodiments, when the candidate message takes the form of picture, the message template may be designed with parameters such as color, layout, etc. of interest to an object in the object group. In other embodiments, when the candidate message takes the form of video, the message template may be designed with parameters such as music, duration, etc. of interest to an object in the object group.

The computing device 120 may then generate the at least one candidate message for the target object, by using the at least one service, the at least one feature and the at least one message template. For example, when the candidate message takes the form of text, the computing device 120 may fill a name of the determined at least one service and an identifier feature of the target object into the reserved fields of the message template, so as to generate the candidate message for the target object. When the candidate message takes the form of picture, the computing device may arrange the name of the determined at least one service at a specific position in the template layout in a color of interest to the target object. When the candidate message takes the form of video, the computing device 120 may generate a video of a suitable duration by combining the name of the determined at least one service with music of interest in a voice manner. In this way, the service, content form and other factors of interest to an object in the object group may be all taken into account, and the candidate message generated may be more likely to promote the target object to subsequently perform potential operations for the recommended service.

With reference to FIG. 2, in step 206, the computing device 120 may select the target message from the at least one candidate message based on the at least one feature. As the target object may have a large number of features and correspond to a plurality of object groups (e.g., the first object group to the fourth object group) that may receive recommendation messages within a predetermined time period, the target object may receive a plurality of messages for different object groups due to different recommendation strategies in a short time period, which may cause unnecessary interference to the target object. With reference to FIG. 3 for illustration, for example, the computing device 120 may determine at least one object feature subset associated with at least one object group to which the target object belongs, and determine a matching degree between the at least one feature and each object feature subset in the at least one object feature subset. The computing device 120 may select a target message 360 from the at least one candidate message 350 based on the matching degree, so as to transmit the target message 360 to the target object 310-T. In some embodiments, the computing device may select a predetermined number (e.g., one) of candidate message with a higher matching degree as the target message.

In some embodiments, the matching degree may be determined by comparing an overlapping degree between the at least one feature of the target object 310-T and the object feature subset of the corresponding object group. For example, in a case that the target object 310-T has eight features (e.g., labels). The target object may correspond to the first object group to the sixth object group, and the message may be transmitted to the first object group to the fourth object group within the predetermined time period. The object feature subset of the first object group includes five of the eight features, the object feature subset of the second object group includes four of the eight features, the object feature subset of the third object group includes four of the eight features, and the object feature subset of the fourth object group includes four of the eight features. Therefore, the candidate message associated with the first object group is determined as the target message.

Additionally or alternatively, in addition to considering the overlapping degree of the above-mentioned features, the matching degree may be further determined based on an importance degree of each feature. For example, different weights (e.g., scores) may be assigned to different overlapping features to determine a matching score representing the matching degree. For example, in a case that the target object 310-T has eight features (e.g., labels), and weights 1, 2, 2, 3, 2, 3, 2 and 1 are set for the eight features, respectively. Overlapping features between the object feature subset of the first object group and the features of the target object include the first feature, the second feature, the third feature, the fifth feature and the sixth feature, then the matching score between the target object and the first object group may be calculated as 10. The matching score between the target object and the second to fourth object groups may be determined in a similar manner. The determined matching scores, for example, may be sorted to determine one or more object groups with higher matching scores, and then determine one or more target messages. In this way, a smaller number of messages that better match the target object may be selected from the candidate messages, and the determined target message may better promote the target object to subsequently perform potential operations for the recommended service.

In some embodiments, when each of the matching degrees (e.g., the matching scores) is not higher than a predetermined threshold, in other words, each of the matching degrees is relatively low, the computing device may randomly select the target message from the at least one candidate message. In some embodiments, when each of the matching degrees is not higher than the predetermined threshold, the computing device may select, from at least one candidate message, a candidate message which will be transmitted to a number of objects and the number ranks higher among all candidate messages (for example, the number of the objects that the candidate message will be transmitted to is the largest), as a target message.

With reference to FIG. 2, in step 208, the computing device 120 may transmit the target message to the target object. As discussed above, the target message may indicate at least one target service recommended to the target object. The content contained in the target message is used to promote the target object to perform at least one behavior for the at least one target service. In some embodiments, a transmission parameter matching the target object may better promote the target object to subsequently perform potential operations for the recommended service. The transmission parameter includes, but is not limited to, a time for transmitting the target message, and a manner for transmitting the target message (for example, short message, official account message, application pop-up, application notification, etc.) Therefore, the computing device may determine a target transmission manner and a target time within the predetermined time period based on the at least one feature of the target object, and transmit the target message to the target object at the target time in the target transmission manner. It may be understood that at least some features of the target object may indicate which manner the target object is sensitive to, for example, a manner frequently used by the target object. At least other features of the target object may indicate a time period when the target object is more active. Therefore, transmitting the target message with the transmission parameters determined based on such features may cause the target object more likely to perform at least one behavior for the at least one target service.

In some embodiments, the computing device 120 may associate an account of the target object with feedback data associated with the at least one target service, in response to transmitting the target message to the target object. For example, if the at least one target service includes a discount or member privilege, the computing device may issue a corresponding electronic coupon or a corresponding channel for purchasing member privilege to the account of the target object.

The embodiments of the present disclosure may filter a plurality of candidate messages that may be transmitted to a same target object within a predetermined time period, so as to transmit a reduced number of messages to the target object, which may prevent interference to the target object. In addition, the selected message may better match the features of the target object, so as to improve a possibility of the target object operating the services contained in the message.

According to the solution of the present disclosure, a number of messages transmitted to the object within the predetermined time period may be reduced.

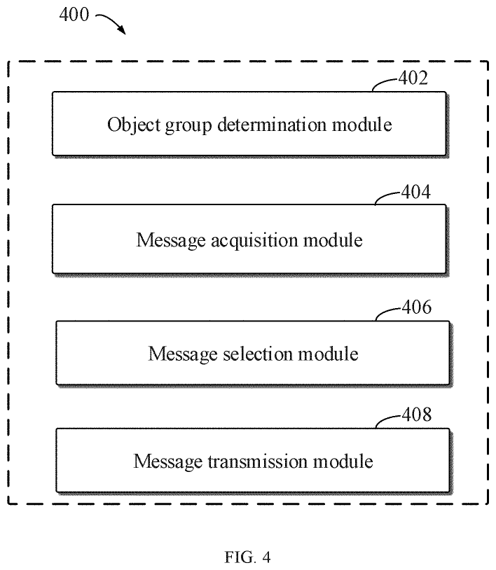

FIG. 4 shows a schematic block diagram of an apparatus 400 of transmitting a message according to some embodiments of the present disclosure. As shown in FIG. 4, the apparatus 400 includes an object group determination module 402 used to determine at least one object group corresponding to a target object from a plurality of object groups, based on at least one feature of the target object. The apparatus 400 may further include a message acquisition module 404 used to acquire at least one candidate message associated with the at least one object group within a predetermined time period, and each of the at least one candidate message indicates at least one candidate service to be recommended to an object in the at least one object group. The apparatus 400 may further include a message selection module 406 used to select a target message from the at least one candidate message based on the at least one feature. The apparatus 400 may further include a message transmission module 408 used to transmit the target message to the target object. The target message indicates at least one target service recommended to the target object.

In some embodiments, the message selection module 406 may include: an object feature subset determination sub-module used to determine at least one object feature subset associated with at least one object group; a matching degree determination sub-module used to determine a matching degree between the at least one feature and each object feature subset in the at least one object feature subset; and a target message selection sub-module used to select the target message based on the matching degree.

In some embodiments, the object group determination module 402 is used to determine the plurality of object groups by: acquiring at least one object feature of each object in an object set; acquiring an object feature set by combining at least one object feature of each object; acquiring a plurality of object feature subsets based on the object feature set; and determining the plurality of object groups from the object set. Each object group is associated with an object feature subset in the plurality of object feature subsets.

In some embodiments, the object group determination module 402 is further used to: re-determine at least one object group corresponding to the target object in response to a change of the at least one feature.

In some embodiments, the message acquisition module 404 may include: an object feature subset acquisition sub-module used to acquire at least one object feature subset associated with at least one object group; a service determination sub-module used to determine at least one service based on the at least one object feature subset; and a candidate message generation sub-module used to generate the at least one candidate message based on the at least one service.

In some embodiments, the candidate message generation sub-module is further used to: determine at least one message template for generating the at least one candidate message, based on the at least one object feature subset; and generate the at least one candidate message for the target object by using the at least one service, the at least one feature and the at least one message template.

In some embodiments, the message transmission module 408 may include: a transmission strategy determination sub-module used to determine a target transmission manner and a target time within the predetermined time period based on the at least one feature; and a target message transmission sub-module used to transmit the target message to the target object at the target time via the target transmission manner.

In some embodiments, the apparatus 400 may further include an association module used to associate an account of the target object with feedback data associated with the at least one target service, in response to transmitting the target message to the target object.

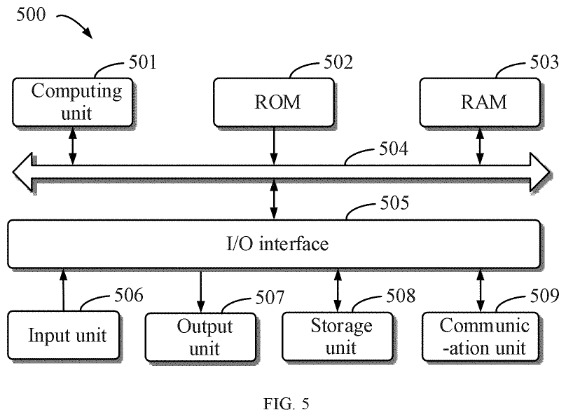

According to the embodiments of the present disclosure, the present disclosure further provides an electronic device, a readable storage medium, and a computer program product. FIG. 5 shows a schematic block diagram of an exemplary electronic device 500 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 501, which may perform various appropriate actions and processing based on a computer program stored in a read-only memory (ROM) 502 or a computer program loaded from a storage unit 508 into a random access memory (RAM) 503. Various programs and data required for the operation of the electronic device 500 may be stored in the RAM 503. The computing unit 501, the ROM 502 and the RAM 503 are connected to each other through a bus 504. An input/output (I/O) interface 505 is also connected to the bus 504.

Various components in the electronic device 500, including an input unit 506 such as a keyboard, a mouse, etc., an output unit 507 such as various types of displays, speakers, etc., a storage unit 508 such as a magnetic disk, an optical disk, etc., and a communication unit 509 such as a network card, a modem, a wireless communication transceiver, etc., are connected to the I/O interface 505. The communication unit 509 allows the electronic device 500 to exchange information/data with other devices through a computer network such as the Internet and/or various telecommunication networks.

The computing unit 501 may be various general-purpose and/or special-purpose processing components with processing and computing capabilities. Some examples of the computing unit 501 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 501 may perform the various methods and processes described above, such as the methods 200 and 300. For example, in some embodiments, any of the methods 200 and 300 may be implemented as a computer software program that is tangibly contained on a machine-readable medium, such as a storage unit 508. In some embodiments, part or all of a computer program may be loaded and/or installed on electronic device 500 via the ROM 502 and/or the communication unit 509. When the computer program is loaded into the RAM 503 and executed by the computing unit 501, one or more steps of the methods 200 and 300 described above may be performed. Alternatively, in other embodiments, the computing unit 501 may be configured to perform any of the methods 200 and 300 in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host. The cloud server is a host product in the cloud computing service system to solve shortcomings of difficult management and weak business scalability existing in the traditional physical host and VPS (Virtual Private Server) service. The server may also be a server of a distributed system or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of transmitting a message, comprising:
determining, from a plurality of object groups, at least one object group corresponding to a target object, based on at least one feature of the target object;
acquiring at least one candidate message associated with the at least one object group within a predetermined time period, wherein each of the at least one candidate message indicates at least one candidate service to be recommended to an object in the at least one object group;
selecting a target message from the at least one candidate message based on the at least one feature; and
transmitting the target message to the target object, wherein the target message indicates at least one target service recommended to the target object.

2. The method of claim 1, wherein the selecting a target message comprises:
determining at least one object feature subset associated with the at least one object group;
determining a matching degree between the at least one feature and each object feature subset in the at least one object feature subset; and
selecting the target message based on the matching degree.

3. The method of claim 1, wherein the plurality of object groups are predetermined by:
acquiring at least one object feature of each object in an object set;
acquiring an object feature set by combining the at least one object feature of each object;
acquiring a plurality of object feature subsets based on the object feature set; and
determining the plurality of object groups from the object set, wherein each object group of the plurality of object groups is associated with an object feature subset in the plurality of object feature subsets.

4. The method of claim 1, wherein the determining at least one object group comprises:
re-determining at least one object group corresponding to the target object, in response to a change of the at least one feature.

5. The method of claim 3, wherein the acquiring at least one candidate message comprises:
acquiring at least one object feature subset associated with the at least one object group;
determining the at least one service based on the at least one object feature subset; and
generating the at least one candidate message based on the at least one service.

6. The method of claim 5, wherein the generating the at least one candidate message comprises:
determining at least one message template for generating the at least one candidate message, based on the at least one object feature subset; and
generating the at least one candidate message for the target object, by using the at least one service, the at least one feature and the at least one message template.

7. The method of claim 1, wherein the transmitting the target message to the target object comprises:
determining a target transmission manner and a target time within the predetermined time period based on the at least one feature; and
transmitting the target message to the target object at the target time via the target transmission manner.

8. The method of claim 1, further comprising:
associating an account of the target object with feedback data associated with the at least one target service, in response to transmitting the target message to the target object.

9. An electronic device, comprising:
at least one processor; and
a memory communicatively connected to the at least one processor, wherein the memory stores instructions executable by the at least one processor, and the instructions, when executed by the at least one processor, cause the at least one processor to:
determine, from a plurality of object groups, at least one object group corresponding to a target object, based on at least one feature of the target object;
acquire at least one candidate message associated with the at least one object group within a predetermined time period, wherein each of the at least one candidate message indicates at least one candidate service to be recommended to an object in the at least one object group;
select a target message from the at least one candidate message based on the at least one feature; and
transmit the target message to the target object, wherein the target message indicates at least one target service recommended to the target object.

10. The electronic device of claim 9, wherein the at least one processor is further configured to:
determine at least one object feature subset associated with the at least one object group;
determine a matching degree between the at least one feature and each object feature subset in the at least one object feature subset; and
select the target message based on the matching degree.

11. The electronic device of claim 9, wherein the at least one processor is further configured to:
acquire at least one object feature of each object in an object set;
acquire an object feature set by combining the at least one object feature of each object;
acquire a plurality of object feature subsets based on the object feature set; and
determine the plurality of object groups from the object set, wherein each object group of the plurality of object groups is associated with an object feature subset in the plurality of object feature subsets.

12. The electronic device of claim 9, wherein the at least one processor is further configured to:
re-determine at least one object group corresponding to the target object, in response to a change of the at least one feature.

13. The electronic device of claim 11, wherein the at least one processor is further configured to:
acquire at least one object feature subset associated with the at least one object group;
determine the at least one service based on the at least one object feature subset; and
generate the at least one candidate message based on the at least one service.

14. The electronic device of claim 13, wherein the at least one processor is further configured to:
determine at least one message template for generating the at least one candidate message, based on the at least one object feature subset; and
generate the at least one candidate message for the target object, by using the at least one service, the at least one feature and the at least one message template.

15. A non-transitory computer-readable storage medium having computer instructions stored thereon, wherein the computer instructions are configured to cause a computer to:
determine, from a plurality of object groups, at least one object group corresponding to a target object, based on at least one feature of the target object;
acquire at least one candidate message associated with the at least one object group within a predetermined time period, wherein each of the at least one candidate message indicates at least one candidate service to be recommended to an object in the at least one object group;
select a target message from the at least one candidate message based on the at least one feature; and
transmit the target message to the target object, wherein the target message indicates at least one target service recommended to the target object.

16. The non-transitory computer-readable storage medium of claim 15, wherein the computer instructions are further configured to cause the computer to:
determine at least one object feature subset associated with the at least one object group;
determine a matching degree between the at least one feature and each object feature subset in the at least one object feature subset; and
select the target message based on the matching degree.

17. The non-transitory computer-readable storage medium of claim 15, wherein the computer instructions are further configured to cause the computer to:
acquire at least one object feature of each object in an object set;
acquire an object feature set by combining the at least one object feature of each object;
acquire a plurality of object feature subsets based on the object feature set; and
determine the plurality of object groups from the object set, wherein each object group of the plurality of object groups is associated with an object feature subset in the plurality of object feature subsets.

18. The non-transitory computer-readable storage medium of claim 15, wherein the computer instructions are further configured to cause the computer to:
re-determine at least one object group corresponding to the target object, in response to a change of the at least one feature.

19. The non-transitory computer-readable storage medium of claim 17, wherein the computer instructions are further configured to cause the computer to:
acquire at least one object feature subset associated with the at least one object group;
determine the at least one service based on the at least one object feature subset; and
generate the at least one candidate message based on the at least one service.

20. The non-transitory computer-readable storage medium of claim 19, wherein the computer instructions are further configured to cause the computer to:
determine at least one message template for generating the at least one candidate message, based on the at least one object feature subset; and
generate the at least one candidate message for the target object, by using the at least one service, the at least one feature and the at least one message template.
